(19) United States
(12) Patent Application Publication
(10) Pub. No.: US 2025/0094512 A1
(43) Pub. Date: Mar. 20, 2025

(54) METHOD AND APPARATUS FOR PROCESSING DATA IN RECOMMENDATION SYSTEM, METHOD AND APPARATUS FOR RECOMMENDATION, DEVICE, AND MEDIUM

(71) Applicant: Beijing Volcano Engine Technology Co., Ltd., Beijing (CN)

(72) Inventors: Yifeng PAN, Beijing (CN); Xiaoxi LIU, Beijing (CN); Xiao WANG, Beijing (CN); Xuemin TONG, Beijing (CN)

(21) Appl. No.: 18/816,275

(22) Filed: Aug. 27, 2024

(30) Foreign Application Priority Data
Sep. 18, 2023 (CN) 202311205267.X

(51) Int. Cl. G06F 16/9535

(52) U.S. Cl. CPC G06F 16/9535

(57) ABSTRACT

The present disclosure relates to the field of computer technology, and discloses a method and apparatus for processing data in a recommendation system, a method and apparatus for recommendation, a device, and a medium. The method provided in the present disclosure includes: obtaining data-to-be-processed of a target industry; analyzing the data-to-be-processed to obtain a plurality of fields and values of the fields in the data-to-be-processed; and querying a recommendation template for a target field corresponding to each field of the fields, and matching a value of the field with the queried target field, to obtain target data for recommendation, wherein the recommendation template is applicable to data-to-be-processed corresponding to a plurality of industries.

### CROSS-REFERENCE TO RELATED APPLICATION(S)

This application claims priority to Chinese Application No. 202311205267.X filed on Sep. 18, 2023, the disclosure of which is incorporated herein by reference in its entity.

### FIELD

The present disclosure relates to the field of computer technology, and in particular, to a method and apparatus for processing data in a recommendation system, a method and apparatus for recommendation, a computer device, and a storage medium.

### BACKGROUND

In a recommendation scenario, different interactive data languages are used to represent data corresponding to different industries. However, when data corresponding to a new industry emerges, it is necessary to re-describe the interactive data language, causing low data processing efficiency.

### SUMMARY

In view of this, the present disclosure provides a method and apparatus for processing data in a recommendation system, a method and apparatus for recommendation, a computer device, and a storage medium, to solve the problem of the data processing efficiency.

In a first aspect, the present disclosure provides a method for processing data in a recommendation system. The method includes: obtaining data-to-be-processed of a target industry; analyzing the data-to-be-processed to obtain a plurality of fields and values of the fields in the data-to-be-processed; and querying a recommendation template for a target field corresponding to each field of the fields, and matching a value of the field with the queried target field, to obtain target data for recommendation, wherein the recommendation template is applicable to data-to-be-processed corresponding to a plurality of industries.

In a second aspect, the present disclosure provides a method for recommendation. The method includes: obtaining a current filtering condition; and querying target data for recommendation based on the current filtering condition to obtain target recommendation data, wherein the target data for recommendation is obtained according to the method for processing data in the recommendation system as described in the first aspect or any implementation corresponding to the first aspect.

In a third aspect, the present disclosure provides an apparatus for processing data in a recommendation system. The apparatus includes: a data-to-be-processed obtaining module configured to obtain data-to-be-processed of a target industry; a data-to-be-processed analysis module configured to analyze the data-to-be-processed to obtain a plurality of fields and values of the fields in the data-to-be-processed; and a target field query module configured to query a recommendation template for a target field corresponding to each field of the fields, and match a value of the field with the queried target field, to obtain target data for recommendation, wherein the recommendation template is applicable to data-to-be-processed corresponding to a plurality of industries.

In a fourth aspect, the present disclosure provides an apparatus for recommendation. The apparatus includes: a filtering condition obtaining module configured to obtain a current filtering condition; and a recommendation data query module configured to query target data for recommendation based on the current filtering condition, to obtain target recommendation data, wherein the target data for recommendation is obtained according to the method for processing data in the recommendation system as described in the first aspect or any implementation corresponding to the first aspect.

In a fifth aspect, the present disclosure provides a computer device, including: a memory and a processor, wherein the memory and the processor are in communicative connection with each other, the memory has computer instructions stored thereon, and the processor is configured to execute the computer instructions to perform the method for processing data in the recommendation system as described in the first aspect or any implementation corresponding to the first aspect, or the method for recommendation as described in the second aspect.

In a sixth aspect, the present disclosure provides a computer-readable storage medium, having computer instructions stored thereon. The computer instructions are used for causing a computer to perform the d method for processing data in the recommendation system as described in the first aspect or any implementation corresponding to the first aspect, or the method for recommendation as described in the second aspect.

The method for processing data in the recommendation system provided by the present disclosure is applicable to the data-to-be-processed of different industries through a recommendation template applicable to data-to-be-processed corresponding to a plurality of industries. After data-to-be-processed of a target industry is obtained, the data-to-be-processed is analyzed to obtain a plurality of fields and values of the various fields represented in the data-to-be-processed. Since the recommendation template can be applied to different industries, the fields obtained by the analysis are matched with target fields in the recommendation template to obtain a target field corresponding to each of the fields in the data-to-be-processed. Thus, the data-to-be-processed is mapped into the recommendation template, in other words, the data-to-be-processed is arranged into a data structure represented by the recommendation template. Due to the universality of the recommendation template, when data-to-be-processed of a new industry emerges, target data for recommendation can be obtained only by field matching, without regenerating a set of data structure for recommendation corresponding to the new industry. Therefore, the data processing efficiency is improved.

### BRIEF DESCRIPTION OF THE DRAWINGS

To describe the technical solutions in the embodiments of the present disclosure or in the existing technology more clearly, the following will briefly introduces the accompanying drawings required to describe the specific implementations or the existing technology. Apparently, the accompanying drawings in the following description show merely some implementations of the present disclosure, and a person of ordinary skilled in the art may still derive other drawings from the accompanying drawings without creative efforts.

FIG. 1 is a schematic flowchart of a method for processing data in a recommendation system according to an embodiment of the present disclosure;

FIG. 2 is a schematic flowchart of another method for processing data in a recommendation system according to an embodiment of the present disclosure;

FIG. 3 is a schematic structural diagram of a first recommendation template according to an embodiment of the present disclosure;

FIG. 4 is a schematic structural diagram of a second recommendation template according to an embodiment of the present disclosure;

FIG. 5 is a schematic flowchart of a method for recommendation according to an embodiment of the present disclosure;

FIG. 6 is a structural block diagram of an apparatus for processing data in a recommendation system according to an embodiment of the present disclosure;

FIG. 7 is a block structural diagram of an apparatus for recommendation according to an embodiment of the present disclosure; and

FIG. 8 is a schematic structural diagram of hardware of a computer device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person skilled in the art based on the embodiments of the present disclosure without making creative efforts shall fall within the protection scope of the present disclosure.

For a recommendation system, after a filtering condition is obtained, data for recommendation is filtered to obtain a recommendation result. Based on this, data needs to be processed to obtain the data for recommendation. In the related technology, different industries have different data expression forms. Therefore, each industry corresponds to one data structure to represent the data used for recommendation.

For example, in the e-commerce industry, the data for recommendation needs to include goods information aggregation, inventory information, and the like. For the long video industry, the data for recommendation needs to include a video duration, video ownership, and the like. For the content community industry, the data for recommendation needs to include keywords, domains, and the like. Therefore, in the related technology, for a newly accessed industry, it is necessary to reconstruct a data structure to represent recommendation data for the newly accessed industry. However, in this method, the data structure needs to be reconstructed, causing low data processing efficiency.

In some other related technology, fields corresponding to the newly accessed industry need to be added based on an original data structure. However, with the increase of accessed industries, the number of added fields will continue to increase. As a result, data structures for recommendation become complex, so that the data processing efficiency is low.

Based on this, the embodiments of the present disclosure provide a method for processing data in a recommendation system, which processes obtained data-to-be-processed through a recommendation template applicable to different industries. In other words, the data-to-be-processed is organized into data structures represented by the recommendation template, thereby processing the data-to-be-processed of different industries into data for recommendation, which are represented using a unified recommendation template.

According to the embodiments of the present disclosure, a method for processing data in a recommendation system is provided. It should be noted that steps shown in the flowchart in the accompanying drawings can be executed in a computer system such as a set of computer-executable instructions. Furthermore, although a logical order is shown in the flowchart. In some cases, the steps shown or described can be executed in an order different from the order here.

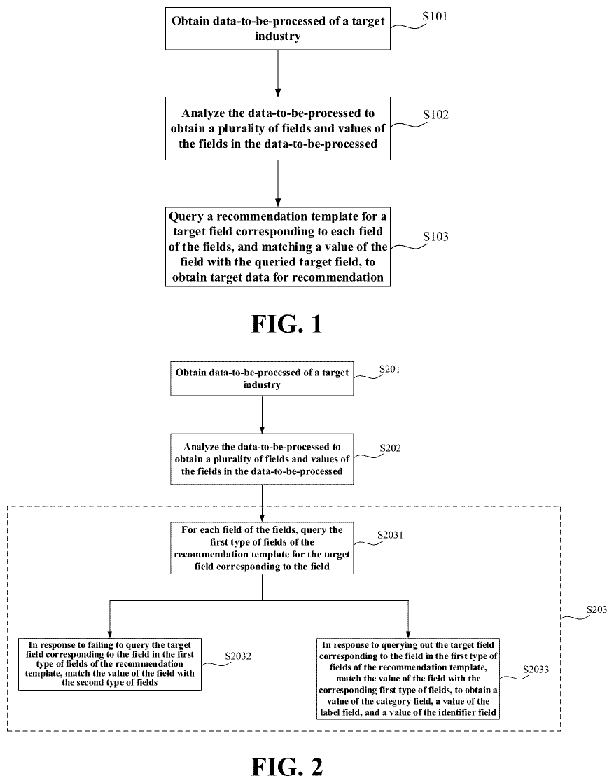

In this embodiment, a method for processing data in a recommendation system is provided, which can be applied to a computer device, such as a computer and a mobile terminal. FIG. 1 is a schematic flowchart of a method for processing data in a recommendation system according to an embodiment of the present disclosure. As shown in FIG. 1, the flow includes the following steps.

At step S101, data-to-be-processed of a target industry is obtained.

The target industry can be one of an automobile industry, a video industry, or a content community industry, or can be a new industry. No restriction will be made on this. The data-to-be-processed is data corresponding to the target industry. For example, in a case that a new car model is introduced in the automobile industry and information of the car model needs to be described, correspondingly, the data-to-be-processed corresponding to it can be obtained. The data-to-be-processed is used for describing the information of the car model, including but not limited to a category, a feature, and other descriptive information.

A way for obtaining the data-to-be-processed can by implemented by providing an information input interface. Interaction with various controls on the information enter interface achieves inputting of content corresponding to various controls. For example, the controls provided on the information input interface include: a category control, a feature control, and a description control. Correspondingly, the content corresponding to the category control is a value of the category field, the content corresponding to the feature control is a value of the feature field, and the content corresponding to the description control is a value of the description field. The data-to-be-processed includes fields corresponding to all the controls and values of the fields.

For example, for the representation of the above car model, three controls are provided on the information input interface. Each control corresponds to one field. The data-to-be-processed can be represented as: the value of field 1, field 1; the value of field 2, field 2, and the value of field 3, field 3.

Of course, a plurality of hierarchies can be used under each field for representation. For example, field 1 includes two first-hierarchy fields, and each first-hierarchy field includes three second-hierarchy fields.

The way for obtaining the data-to-be-processed may be implemented by acquiring an image of the data-to-be-processed, analyzing the image, and automatically filling the content corresponding to the various controls with the image to obtain the values of the various field.

Alternatively, the data-to-be-processed of the target industry may be obtained in another way. The way is not restricted here and will be specifically set according to an actual need.

At step S102, the data-to-be-processed is analyzed to obtain a plurality of fields and values of the fields in the data-to-be-processed.

The way for analyzing the data-to-be-processed can be to implemented by querying identifiers in the data-to-be-processed to determine the various fields and the values of the fields, or by performing character recognition on the data-to-be-processed to obtain the various fields and the values of the fields. The number of the fields included in the data-to-be-processed is determined according to the needs of the various industries. No restriction will be made on this.

At step S103, a recommendation template is queried for a target field corresponding to each field of the fields, and a value of the field is matched with the queried target field, to obtain target data for recommendation.

The recommendation template is applicable to data-to-be-processed corresponding to a plurality of industries.

The target fields in the recommendation template ae fixed. Which field or fields that the various target fields can correspond can be determined by maintained correspondence relationships, or by representing, during the generation of the data-to-be-processed, corresponding descriptive information using the fields that are the same as the target fields. For example, in the recommendation template, the category field is represented by field a. During the generation of the data-to-be-processed, the category field in the data-to-be-processed is also represented by field a. Therefore, by searching the recommendation template for the same field name, the target field corresponding to each field of the fields can be obtained.

After the target field is queried out, the value of the field is matched with the queried target field to obtain the value of the target field. By parity of reasoning, the values of the various target fields in the recommendation template can be obtained, thereby obtaining the target data for recommendation. In other words, the data-to-be-processed is mapped to the target data for recommendation.

The method for processing data in the recommendation system provided by this embodiment is applicable to the data-to-be-processed of different industries through a recommendation template applicable to data-to-be-processed corresponding to a plurality of industries. After data-to-be-processed of a target industry is obtained, the data-to-be-processed is analyzed to obtain a plurality of fields and values of the various fields in the data-to-be-processed. Since the recommendation template can be applied to different industries, each field obtained by the analysis is matched with a target field in the recommendation template to obtain a target field corresponding to the field in the data-to-be-processed. Thus, the data-to-be-processed is mapped into the recommendation template, in other words, the data-to-be-processed is arranged into a data structure represented by the recommendation template. Due to the universality of the recommendation template, when data-to-be-processed of a new industry emerges, target data for recommendation can be obtained only by field matching, without regenerating a set of data structure for recommendation corresponding to the new industry. Therefore, the data processing efficiency is improved.

In this embodiment, a method for processing data in a recommendation system is provided, which can be applied to a computer device, such as a computer and a mobile terminal. FIG. 2 is a schematic flowchart of a method for processing data in a recommendation system according to an embodiment of the present disclosure. As shown in FIG. 2, the flow includes the following steps.

At step S201, data-to-be-processed of a target industry is obtained. For details, refer to step S101 of the embodiment shown in FIG. 1. The details will not be elaborated here.

At step S202, the data-to-be-processed is analyzed to obtain a plurality of fields and values of the fields in the data-to-be-processed. For details, refer to step S102 of the embodiment shown in FIG. 1. The details will not be elaborated here.

At step S203, a recommendation template is queried for a target field corresponding to each field of the fields, and a value of the field is matched with the queried target field, to obtain target data for recommendation.

The recommendation template is applicable to data-to-be-processed corresponding to a plurality of industries. The recommendation template includes a first type of fields and a second type of fields. The first type of fields includes a category field, a label field, and an identifier field. Based on this, step S203 mentioned above includes the following steps.

At step S2031, for each field of the fields, the first type of fields of the recommendation template is queried for the target field corresponding to the field.

The first type of fields is used for storing the values of fields shared for different industries, and the second type of fields is used for representing the values of differentiated fields. During the querying for the target field, for each field of the fields obtained by the analysis, the first type of fields of the recommendation template is queried, thus obtaining the fields, corresponding to the first type of fields, in the data-to-be-processed. In other words, the fields corresponding to the category field, the label field, and the identifier field in the recommendation template are obtained from the data-to-be-processed by query.

At step S2032, in response to failing to query the target field corresponding to the field in the first type of fields of the recommendation template, the value of the field is matched with the second type of fields.

The second type of fields is used for storing values of differentiated fields of different industries.

For the fields in the data-to-be-processed, in a case that there is a field that is not in the first type of fields, the value of the field is matched with the second type of fields. Due to the fact that the second type of fields corresponds to the differentiated fields of different industries, during matching of the fields, the fields are first matched with the first type of fields, and in a case that no target field can be matched, the field is matched with the second type of fields to ensure the accuracy of a target field matching result.

At step S2033, in response to querying out the target field corresponding to the field in the first type of fields of the recommendation template, the value of the field is matched with the corresponding first type of fields, to obtain a value of the category field, a value of the label field, and a value of the identification field.

In a case that the corresponding target field is matched in the recommendation template, it is further determined that the whether the field correspond to the category field, the label field, or the identifier field. Correspondingly, the value of the category field, the value of the label field, and the value of the identifier field can be obtained.

The category field is used for supporting an expression requirement of the category information of the various industries, and can support multiple hierarchies of categories. No restriction is made on the specific number of hierarchies. Of course, the same hierarchy further supports a plurality of category values.

The label field is a field used for representing a feature of an object, and the identifier field is used for representing a recommendable or non-recommendable identifier field.

In some optional implementations, step S2033 described above includes the following steps.

At step a1, a hierarchy of the field corresponding to the category field is queried.

At step a2, in response to a determination that a quantity of the hierarchies of the field is greater than 1, a field-hierarchy relationship of the field corresponding to the category field and a sub-field of each of the hierarchies are obtained.

At step a3, the value of the category field is determined based on the field-hierarchy relationship and the sub-field of each of the hierarchies.

In the data-to-be-processed, the field used for representing the category information can have one hierarchy or multiple hierarchies. In a case that the quantity of the hierarchies of the field in the data-to-be-processed is greater than 1, it indicates that the field has multiple hierarchies. In case of multiple hierarchies, the field is further analyzed to obtain the field-hierarchy relationship and the sub-field of each of the hierarchies.

For example, in a case that the category is shoes, a first hierarchy indicates basketball shoes; second hierarchies include men's shoes, women's shoes, and children's shoes; and each second hierarchy includes third hierarchies corresponding to various sizes. Therefore, after the field is analyzed, the field-hierarchy relationship and the sub-field of each of the hierarchies can be obtained. The field-hierarchy relationship is used for representing supervisor-subordinate relationship among the hierarchies. For example, the second hierarchy is a subordinate hierarchy of the first hierarchy, and the third hierarchy is a subordinate hierarchy of the second hierarchy.

After the field-hierarchy relationship and the sub-field of each of the hierarchies are obtained, the sub-field of each of the hierarchies and the value of the sub-field are matched with the category field, and the value of the category field is obtained. Continuing to use the above example, the value of the first-hierarchy field of the category field is basketball shoes; the values of the second-hierarchy fields include men's shoes, women's shoes, and children's shoes; and the values of the third-hierarchy field include corresponding sizes.

The category field can achieve representation of multi-hierarchy fields, thereby supporting the need for representing scenario category information of various industries.

The method for processing data in the recommendation system provided in this embodiment includes a first type of fields and a second type of fields in the recommendation template. The second type of fields is used for storing values of differentiated fields of different industries. Since different industries have their own personalized descriptions in addition to the general characteristics, the first type of fields corresponds to the general characteristics, and the second type of fields corresponds to the differentiated characteristics, which achieves a complete expression of the data-to-be-processed of different industries. The first type of fields includes the category field, the label field, and the identifier field. During the matching of each field, the first type of fields is first queried to obtain the value of the target field corresponding to the general characteristics, to ensure the accuracy of the first type of fields.

In some optional implementations, in response to a determination that the recommendation template is a first recommendation template, the target data corresponding to the first recommendation template is used for recommendation of forward indexes, and the first recommendation template includes the first type of fields and the second type of fields.

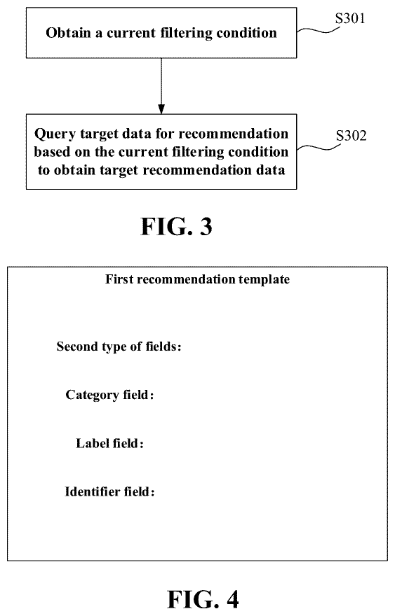

The first recommendation template is used for a recommendation scenario of the forward indexes. For example, FIG. 3 shows a schematic diagram of the first recommendation template. The first recommendation template includes the second type of fields, a category field, a label field, and an identifier field. The second type of fields is used for storing the values of the differentiated fields of different industries. In other words, in the first recommendation template, the second type of fields ensures that the first recommendation template can support more flexible service field adjustment, thereby supporting a more flexible dynamic filtering need.

In some optional implementations, in response to a determination that the recommendation template is a second recommendation template, the target data corresponding to the second recommendation template is used for recommendation of candidate indexes, the second recommendation template includes the first type of fields and the second type of fields, the first type of fields further includes function fields, and the function fields are used for storing values of the function fields of the candidate indexes.

The second recommendation template is used for a recommendation scenario of the candidate indexes. For example, FIG. 4 shows a schematic diagram of the second recommendation template. The second recommendation template includes fields that are the same as those in the first recommendation template and additional function fields. Specifically, the second recommendation template includes the second type of fields, a category field, a label field, an identifier field, a channel field, a creation time field, and a feature field.

Specifically, the function fields include a channel field, a creation time field, and a feature field. Based on this, step S203 described above further includes the following operation.

For each field of the fields, the v function fields of the second recommendation template are queried for the target field corresponding to the field, to obtain values of the channel field, the creation time field, and the feature field. The channel field is used for representing different candidate indexes classified based on different industries, the creation time field is used for representing time-based recall indexes of different industries, and the feature field is used for representing feature information of the data-to-be-processed.

During the matching of the target field, the various function fields in the second recommendation template are queried to obtain the values of the various function fields. In other words, the values of the channel field, the creation time field, and the feature field are obtained.

After the values of the various fields in the second recommendation template are filled, the target data for the candidate indexes can be obtained. Correspondingly, after the values of the various fields in the first recommendation template are filled, the target data for the forward indexes can be obtained.

The function fields include a channel field, a creation time field, and a feature field, to provide input data for construction of recall indexes.

In some optional implementations, step S202 described above includes the following steps.

At step b1, a connection identifier in the data-to-be-processed is queried, wherein the connection identifier is used for connecting different fields.

At step b2, the data-to-be-processed is divided based on the connection identifier, to obtain the plurality of fields and the values of the fields.

Different fields in the data-to-be-processed are connected through the connection identifiers, in other words, the data-to-be-processed is represented as a character string through the connection identifiers. The connection identifiers are identifier types set according to a need, and the specific identifier types are not limited here and are set according to an actual need. After the connection identifiers are determined, the data-to-be-processed is divided based on the connection identifiers to obtain the plurality of fields and the values of the fields.

In the data-to-be-processed, the plurality of fields are connected through the connection identifiers. Correspondingly, when the data-to-be-processed is analyzed, the plurality of fields and the values of the fields can be accurately obtained by recognizing the connection identifiers.

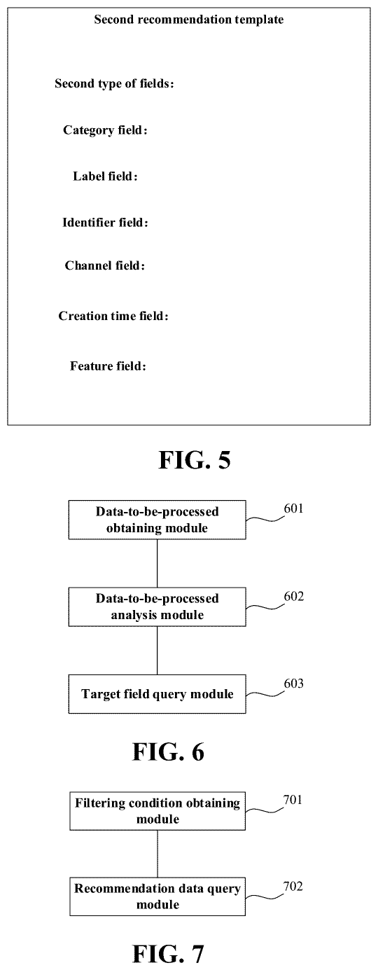

In this embodiment, a method for data recommendation is provided, which can be applied to a computer device, such as a computer and a mobile terminal. FIG. 5 is a schematic flowchart of a method for data recommendation according to an embodiment of the present disclosure. As shown in FIG. 5, the flow includes the following steps.

At step S301, a current filtering condition is obtained.

The current filtering condition is a filtering condition input interactively on a filtering interface in a data recommendation scenario. The current filtering condition is set according to a current filtering scenario. One or more filtering conditions can be input on the filtering interface. In a case that more filtering conditions are given, a subsequent recommendation range is finer.

Obviously, a recommendation mode for use, i.e., whether forward indexes or candidate indexes are used, is determined according to the given current filtering condition.

At step S302, target data for recommendation is queried based on the current filtering condition to obtain target recommendation data.

The target data for recommendation is obtained according to the method for processing data in the recommendation system described above.

After the current filtering condition is obtained, the target data is queried. A query mode includes but is not limited to field indexes. No specific restriction will be made on this. The target data for recommendation is obtained according to the above method for processing data in the recommendation system. This is specifically described in the above and will not be elaborated here.

According to the method for recommendation provided in this embodiment, the current filtering condition is used to query the target data for recommendation during data recommendation. As the target data for recommendation is obtained based on a recommendation template, different industries do not need to be distinguished. Therefore, the data recommendation efficiency and accuracy are improved.

As a specific application embodiment of the present disclosure, the data-to-be-processed in the automobile industry is mapped to a recommendation template to obtain the target data for recommendation corresponding to the data-to-be-processed in the automobile industry. The data-to-be-processed in the video industry is mapped to a recommendation template to obtain the target data for recommendation corresponding to the data-to-be-processed in the video industry. The data-to-be-processed of the e-commerce industry is mapped to a recommendation template to obtain the target data for recommendation corresponding to the data-to-be-processed of the e-commerce industry. In other words, the same recommendation template can be used to map the data-to-be-processed of different industries into the target data for recommendation that is represented by the same data structure.

This embodiment further provides an apparatus for processing data in a recommendation system and an apparatus for recommendation. The apparatuses are configured to implement the above embodiments and preferred implementations. Those contents that have been described will not be elaborated. As used below, the term “module” can be a combination of software and/or hardware that implements a predetermined function. Although the apparatus described in the following embodiments is preferably implemented in software, the implementation of hardware or a combination of software and hardware is also possible and envisioned.

This embodiment provides an apparatus for processing data in a recommendation system. As shown in FIG. 6, the apparatus includes the following modules.

A data-to-be-processed obtaining module 601 is configured to obtain data-to-be-processed of a target industry.

A data-to-be-processed analysis module 602 is configured to analyze the data-to-be-processed to obtain a plurality of fields and values of the fields in the data-to-be-processed.

A target field query module 603 is configured to query a recommendation template for a target field corresponding to each field of the fields, and match a value of the field with the queried target field, to obtain target data for recommendation, wherein the recommendation template is applicable to data-to-be-processed corresponding to a plurality of industries.

In some optional implementations, the recommendation template includes a first type of fields and a second type of fields, and the target field query module 603 includes the following units.

A query unit for first type of fields is configured to, for each field of the fields, query the first type of fields of the recommendation template for the target field corresponding to the field.

A determining unit for second type of fields is configured to, in response to failing to query the target field corresponding to the field in the first type of fields of the recommendation template, match the value of the field with the second type of fields, wherein the second type of fields is used for storing values of differentiated fields of different industries.

In some optional implementations, the first type of fields includes a category field, a label field, and an identifier field, and the target field query module 603 further includes the follow units.

A target field determining unit is configured to, in response to querying out the target field corresponding to the field in the first type of fields of the recommendation template, match the value of the field with the corresponding first type of fields, to obtain a value of the category field, a value of the label field, and a value of the identifier field.

In some optional implementations, in response to a determination the target field is the category field, the target field determining unit includes the following subunits.

A hierarchy query subunit is configured to query a hierarchy of the field corresponding to the category field.

A hierarchical relationship obtaining subunit is configured to, in response to a determination that that a quantity of the hierarchies of the field is greater than 1, obtain a field-hierarchy relationship of the field corresponding to the category field and a sub-field of each of the hierarchies.

A category field determining subunit is configured to determine the value of the category field based on the field-hierarchy relationship and the sub-field of each of the hierarchies.

In some optional implementations, in response to a determination that the recommendation template is a first recommendation template, the target data corresponding to the first recommendation template is used for recommendation of forward indexes, and the first recommendation template includes the first type of fields and the second type of fields.

In some optional implementations, in response to a determination that the recommendation template is a second recommendation template, the target data corresponding to the second recommendation template is used for recommendation of candidate indexes, the second recommendation template includes the first type of fields and the second type of fields, the first type of fields further includes function fields, and the function fields are used for storing values of the function fields of the candidate indexes.

In some optional implementations, the function fields include a channel field, a creation time field, and a feature field. The target field query module 603 further includes the following units.

A function field determining unit is configured to, for the various fields, query the function fields of the second recommendation template for the target field corresponding to the field, to obtain values of the channel field, the creation time field, and the feature field. The channel field is used for representing different candidate indexes classified based on different industries. The creation time field is used for representing time-based recall indexes of different industries. The feature field is used for representing feature information of the data-to-be-processed.

In some optional implementations, the data-to-be-processed analysis module 602 includes the following units.

A connection identifier query unit is configured to query a connection identifier in the data-to-be-processed, wherein the connection identifier is used for connecting different fields.

A division unit is configured to divide the data-to-be-processed based on the connection identifier, to obtain the plurality of fields and the values of the fields.

This embodiment provides a filtering apparatus, as shown in FIG. 7, the apparatus includes the following modules.

A filtering condition obtaining module 701 is configured to obtain a current filtering condition.

A recommendation data query module 702 is configured to query target data for recommendation based on the current filtering condition, to obtain target recommendation data, wherein the target data for recommendation is obtained according to the above method for processing data in the recommendation system of any one of the above embodiments.

The apparatus for processing data in the recommendation system and the filtering apparatus in this embodiment are presented in the form of functional units. The units here are Application Specific Integrated Circuit (ASICs), processors and memories that execute one or more software or fixed programs, and/or other devices that can provide the above functions.

The further function descriptions of the above modules and units are the same as the corresponding embodiments mentioned above, and will not be elaborated here.

The embodiments of the present disclosure further provide a computer device with the apparatus for processing data in the recommendation system shown in FIG. 6 or the filtering apparatus shown in FIG. 7.

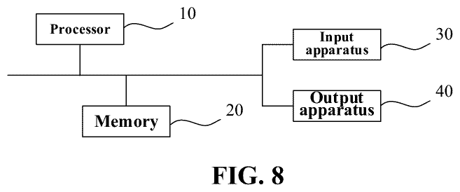

Referring to FIG. 8, FIG. 8 is a schematic structural diagram of a computer device provided in an embodiment of the present disclosure. As shown in FIG. 8, the computer device includes: one or more processors 10, a memory 20, and interfaces for connecting the various components, including a high-speed interface and a low-speed interface. The various components are in communicative connection to each other using different buses, and can be mounted on a common motherboard or in other ways as needed. The processor can process instructions executed in the computer device, including instructions stored in or on the memory to display graphical information of a Graphical User Interface (GUI) on an external input/output apparatus (such as a display device coupled to an interface). In some optional implementations, if necessary, a plurality pf processors and/or a plurality of buses can be used together with a plurality of memories and a plurality of memories. Similarly, a plurality of computer devices can be connected. The various devices provide some necessary operations (such as serving as a server array, a group of blade servers, or a multiprocessor system). In FIG. 8, one processor 10 is taken as an example.

The processor 10 can be a central processing unit, a network processor, or a combination thereof. The processor 10 can further include a hardware chip. The above hardware chip can be an ASIC, a programmable logic device, or a combination thereof. The above-mentioned programmable logic device can be a complex programmable logic device, a field programmable logic gate array, a general-purpose array logic, or any combination thereof.

The memory 20 stores instructions that can be executed by at least one processor 10 to cause the at least one processor 10 to implement the method illustrated in the above embodiment.

The memory 20 may include a program storage region and a data storage region. The program storage region may store an operating system and an application program required by at least one function. The data storage region may store data created according to use of the computer device. In addition, the memory 20 may include a high-speed random access memory and may further include a non-transient memory, such as at least one disk storage device, a flash memory device, or other non-transient solid-state storage devices. In some optional implementations, the memory 20 includes a memory remotely located with respect to the processor 10. These remote memories can be connected to the computer device through a network. Examples of the above network include, but are not limited to, internets, intranets, local area networks, mobile communication networks, and combinations thereof.

The memory 20 may include a volatile memory, such as a random access memory. Alternatively, the memory may include a non-volatile memory, such as a flash memory, a hard disk drive, or a solid-state disk drive. The memory 20 can further include a combination of the aforementioned types of memories.

The computer device further includes an input apparatus 30 and an output apparatus 40. The processor 10, the memory 20, the input apparatus 30, and the output apparatus 40 can be connected through a bus or in another way. By way of example, FIG. 8 shows bus connection.

The input apparatus 30 may receive input numeric or character information and generate key signal inputs related to user settings and function control of the computer device, such as a touch screen, a keypad, a mouse, a trackboard, a touch panel, an indicator stem, one or more mouse buttons, a trackball, and a control lever. The output apparatus 40 may include a display device, an auxiliary lighting apparatus (such as an LED), a tactile feedback apparatus (such as a vibration motor), and the like. The above display device includes but is not limited to a liquid crystal display, a light emitting diode, a display, and a plasma display. In some optional implementations, the display device can be a touch screen.

The embodiments of the present disclosure further provide a computer-readable storage medium. The above method according to the embodiments of the present disclosure can be implemented in hardware or firmware, or can be implemented as being recordable on a storage medium, or implemented as a computer code that is downloaded through a network, originally stored on a remote storage medium or a non-transient machine-readable storage medium, and to be stored on a local storage medium. Therefore, the method described here can be processed by software stored on a storage medium using a general-purpose computer, a dedicated processor, or programmable or dedicated hardware. The storage medium can be a magnetic disk, a compact disc, a read-only memory, a random access memory, a flash memory, a hard disk drive, a solid-state hard disk drive, or the like. Further, the storage medium may further include a combination of the aforementioned types of memories. It can be understood that a computer, processor, microprocessor controller, or programmable hardware includes a storage component that can store or receive software or a computer code. When the software or computer code is accessed and executed by the computer, processor, or hardware, the method illustrated above is implemented.

It can be understood that before use of the technical solutions disclosed in various embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an optional but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

It can be understood that the above notification and the above user authorization obtaining process are only illustrative and do not constitute a limitation on the implementations of the present disclosure. Other methods that meet the relevant laws and regulations can also be applied to the implementations of the present disclosure.

Although the embodiments of the present disclosure are described in conjunction with the accompanying drawings, a person skilled in the art may make various modifications and transformations without departing from the spirit and scope of the present disclosure. These modifications and transformations shall fall within the scope defined by the attached claims.

I/we claim:

1. A method for processing data in a recommendation system, comprising:
obtaining data-to-be-processed of a target industry;
analyzing the data-to-be-processed to obtain a plurality of fields and values of the fields in the data-to-be-processed; and
querying a recommendation template for a target field corresponding to each field of the fields, and matching a value of the field with the queried target field, to obtain target data for recommendation, wherein the recommendation template is applicable to data-to-be-processed corresponding to a plurality of industries.

2. The method according to claim 1, wherein the recommendation template comprises a first type of fields and a second type of fields, and
querying the recommendation template for the target field corresponding to each field of the fields, and matching the value of the field with the queried target field, to obtain target data for recommendation comprise:
for each field of the fields, querying the first type of fields of the recommendation template for the target field corresponding to the field; and
in response to failing to query the target field corresponding to the field in the first type of fields of the recommendation template, matching the value of the field with the second type of fields, wherein the second type of fields is used for storing values of differentiated fields of different industries.

3. The method according to claim 2, wherein the first type of fields comprises a category field, a label field, and an identifier field, and
querying the recommendation template for the target field corresponding to each field of the fields, and matching the value of the field with the queried target field, to obtain target data for recommendation further comprise:
in response to querying out the target field corresponding to the field in the first type of fields of the recommendation template, matching the value of the field with the corresponding first type of fields, to obtain a value of the category field, a value of the label field, and a value of the identifier field.

4. The method according to claim 3, wherein in response to a determination that the target field is the category field, matching the value of the field with the corresponding first type of fields, to obtain the value of the category field comprises:
querying a hierarchy of the field corresponding to the category field;
in response to a determination that a quantity of the hierarchies of the field is greater than 1, obtaining a field-hierarchy relationship of the field corresponding to the category field and a sub-field of each of the hierarchies; and
determining the value of the category field based on the field-hierarchy relationship and the sub-field of each of the hierarchies.

5. The method according to claim 3, wherein in response to a determination that the recommendation template is a first recommendation template, the target data corresponding to the first recommendation template is used for recommendation of forward indexes, and the first recommendation template comprises the first type of fields and the second type of fields.

6. The method according to claim 3, wherein in response to a determination that the recommendation template is a second recommendation template, the target data corresponding to the second recommendation template is used for recommendation of candidate indexes, the second recommendation template comprises the first type of fields and the second type of fields, the first type of fields further comprises function fields, and the function fields are used for storing values of the function fields of the candidate indexes.

7. The method according to claim 6, wherein the function fields comprise a channel field, a creation time field, and a feature field, and
querying the recommendation template for the target field corresponding to each field of the fields, and matching the value of the field with the queried target field, to obtain target data for recommendation further comprises:
for each field of the fields, querying the function fields of the second recommendation template for the target field corresponding to the field, to obtain values of the channel field, the creation time field, and the feature field, wherein the channel field is used for representing different candidate indexes classified based on different industries, the creation time field is used for representing time-based recall indexes of different industries, and the feature field is used for representing feature information of the data-to-be-processed.

8. The method according to claim 1, wherein analyzing the data-to-be-processed to obtain the plurality of fields and values of the fields in the data-to-be-processed comprises:
querying for a connection identifier in the data-to-be-processed, wherein the connection identifier is used for connecting different fields; and
dividing the data-to-be-processed based on the connection identifier to obtain the plurality of fields and the values of the fields.

9. A method for recommendation, comprising:
obtaining a current filtering condition; and
querying target data for recommendation based on the current filtering condition to obtain target recommendation data, wherein the target data for recommendation is obtained according to the method for processing data in the recommendation system according to claim 1.

10. A computer device, comprising:
a memory; and
a processor, wherein the memory and the processor are in communicative connection with each other, the memory has computer instructions stored thereon, and the processor is configured to execute the computer instructions to:
obtain data-to-be-processed of a target industry;
analyze the data-to-be-processed to obtain a plurality of fields and values of the fields in the data-to-be-processed; and
query a recommendation template for a target field corresponding to each field of the fields, and match a value of the field with the queried target field, to obtain target data for recommendation, wherein the recommendation template is applicable to data-to-be-processed corresponding to a plurality of industries.

11. The computer device according to claim 10, wherein the recommendation template comprises a first type of fields and a second type of fields, and
the computer instructions to query the recommendation template for the target field corresponding to each field of the fields, and match the value of the field with the queried target field, to obtain target data for recommendation comprise computer instructions to:
for each field of the fields, query the first type of fields of the recommendation template for the target field corresponding to the field; and
in response to failing to query the target field corresponding to the field in the first type of fields of the recommendation template, match the value of the field with the second type of fields, wherein the second type of fields is used for storing values of differentiated fields of different industries.

12. The computer device according to claim 11, wherein the first type of fields comprises a category field, a label field, and an identifier field, and
the computer instructions to query the recommendation template for the target field corresponding to each field of the fields, and match the value of the field with the queried target field, to obtain target data for recommendation further comprise computer instructions to:
in response to querying out the target field corresponding to the field in the first type of fields of the recommendation template, match the value of the field with the corresponding first type of fields, to obtain a value of the category field, a value of the label field, and a value of the identifier field.

13. The computer device according to claim 12, wherein the computer instructions to in response to a determination that the target field is the category field, match the value of the field with the corresponding first type of fields, to obtain the value of the category field comprise computer instructions to:
query a hierarchy of the field corresponding to the category field;
in response to a determination that a quantity of the hierarchies of the field is greater than 1, obtain a field-hierarchy relationship of the field corresponding to the category field and a sub-field of each of the hierarchies; and
determine the value of the category field based on the field-hierarchy relationship and the sub-field of each of the hierarchies.

14. The computer device according to claim 12, wherein in response to a determination that the recommendation template is a first recommendation template, the target data corresponding to the first recommendation template is used for recommendation of forward indexes, and the first recommendation template comprises the first type of fields and the second type of fields.

15. The computer device according to claim 12, wherein in response to a determination that the recommendation template is a second recommendation template, the target data corresponding to the second recommendation template is used for recommendation of candidate indexes, the second recommendation template comprises the first type of fields and the second type of fields, the first type of fields further comprises function fields, and the function fields are used for storing values of the function fields of the candidate indexes.

16. The computer device according to claim 15, wherein the function fields comprise a channel field, a creation time field, and a feature field, and
the computer instructions to query the recommendation template for the target field corresponding to each field of the fields, and match the value of the field with the queried target field, to obtain target data for recommendation further comprise computer instructions to:
for each field of the fields, query the function fields of the second recommendation template for the target field corresponding to the field, to obtain values of the channel field, the creation time field, and the feature field, wherein the channel field is used for representing different candidate indexes classified based on different industries, the creation time field is used for representing time-based recall indexes of different industries, and the feature field is used for representing feature information of the data-to-be-processed.

17. The computer device according to claim 10, wherein the computer instructions to analyze the data-to-be-processed to obtain the plurality of fields and values of the fields in the data-to-be-processed comprise computer instructions to:
query for a connection identifier in the data-to-be-processed, wherein the connection identifier is used for connecting different fields; and
divide the data-to-be-processed based on the connection identifier to obtain the plurality of fields and the values of the fields.

18. A computer device, comprising:
a memory; and
a processor, wherein the memory and the processor are in communicative connection with each other, the memory has computer instructions stored thereon, and the processor is configured to execute the computer instructions to:
obtain a current filtering condition; and
query target data for recommendation based on the current filtering condition to obtain target recommendation data, wherein the target data for recommendation is obtained according to the method for processing data in the recommendation system according to claim 1.

19. A non-transitory computer-readable storage medium, having computer instructions stored thereon, wherein the computer instructions are used for configuring a computer to:
obtain data-to-be-processed of a target industry;
analyze the data-to-be-processed to obtain a plurality of fields and values of the fields in the data-to-be-processed; and
query a recommendation template for a target field corresponding to each field of the fields, and match a value of the field with the queried target field, to obtain target data for recommendation, wherein the recommendation template is applicable to data-to-be-processed corresponding to a plurality of industries.

20. A non-transitory computer-readable storage medium, having computer instructions stored thereon, wherein the computer instructions are used for configuring a computer to
obtain a current filtering condition; and
query target data for recommendation based on the current filtering condition to obtain target recommendation data, wherein the target data for recommendation is obtained according to the method for processing data in the recommendation system according to claim 1.
